(19) United States
(12) Patent Application Publication
(10) Pub. No.: US 2009/0008827 A1
(43) Pub. Date: Jan. 8, 2009

(54) Aperture adapters for laser-based coating removal end-effector

(75) Inventors: Mitchell R. Wool, Sunnyvale, CA (US); James W. Thomas, Los Altos, CA (US)

Correspondence Address: HAVERSTOCK & OWENS LLP, 162 N WOLFE ROAD, SUNNYVALE, CA, 94086, US

(73) Assignee: General Lasertronics Corporation, a corporation of the State of California

(21) Appl. No.: 12/217,435

(22) Filed: Jul. 3, 2008

Related U.S. Application Data
(60) Provisional application No. 60/958,667, filed on Jul. 5, 2007.

(51) Int. Cl. B29C 35/08

(52) U.S. Cl. 264/400; 425/174.4

(57) ABSTRACT

A coating removal device, comprising a head component and a body component, removes a coating from a surface. The head component has a means for detachably engaging a removable aperture adapter and for enabling an operator to change and use another aperture adapter for a different application of the device. Aperture adapters are configured for specified deflections of laser beams. In some embodiments, the device is coupled to a waste collection shroud, which achieves 100% collection of waste products without surface contact by establishing a suction flow normal to and in a direction toward a centerline of the device, despite presence of a purge flow that is ejected along with laser beams from the aperture adapter. In other embodiments, the device has a camera for enabling the operator to view an ablation processing region on a display when the device is in operation within a confined space.

### RELATED APPLICATIONS

This application claims priority of U.S. provisional application Ser. No. 60/958,667, filed Jul. 5, 2007, and entitled “Aperture Adapters for Laser-Based Coating Removal End-Effector,” by the same inventors. This application incorporates U.S. provisional application Ser. No. 60/958,667, filed Jul. 5, 2007, and entitled “Aperture Adapters for Laser-Based Coating Removal End-Effector” in its entirety by reference.

### FIELD OF THE INVENTION

The invention relates to laser-based coating removal end-effectors. In particular, the invention relates to aperture adapters for a laser-based coating removal end-effector.

### BACKGROUND OF THE INVENTION

Delivery of certain wavelengths of radiant energy is facilitated by transmission along flexible silica fibers. The energy is dispersed from the emitting end of an optical fiber in a widening cone. The energy intensity is generally symmetric about the central fiber axis (e.g., uniformly distributed in azimuth) at the emitting end. The distribution of emitted energy orthogonal to the azimuth angle is highly non-uniform, with highest intensity at the central axis, rapidly decreasing with increasing divergence angle relative to the central fiber axis, sometimes approximated by a power cosine function of the divergence angle.

Energy beam guiding structures are known that use refractive media (e.g. optical lenses) in combination with movable reflective or refractive media (e.g. mirrors or prisms) to focus and direct diverging radiant energy disposed around the input beam axis to a target of interest. The optical lenses typically convert (collimate) the dispersing radiant energy to a second beam with the radiant energy directed more parallel to the input beam axis. The second beam's energy is distributed over a cross-sectional area defined on a target surface oriented in a transverse plane intersecting the optical axis of the second beam. The size of the defined area is typically limited by the diameter of the lenses. The movable media are coupled to transporting mechanisms and are positioned to modify the direction of the collimated beam as a function of time, typically in a raster pattern scan mode. The dynamic positioning of the media is generally arranged so that the energy of the second beam, averaged over a multiple number of scan cycles, is distributed as a less intense, more uniform energy intensity distribution over the desired target surface area. In addition, one or more condensing (focusing) lens can be used to focus the collimated beam energy to a fine point at the target's surface. Combinations of mirrors, prisms and/or lenses are used to achieve both effects. The typical objective of these combined reflective and refractive elements is to modify the beams intensity distribution over the width of a limited transverse area and to move the scan area over a target surface to produce a less intense, more uniform, energy intensity distribution over a larger area.

In previous laser scanning heads, the beam is typically reflected from two raster scanning mirrors movably mounted in a housing where they are disposed with the first mirror intercepting the input beam, reflecting it to the second mirror, which then reflects the beam toward the target. Alternatively, movable lenses and prisms deflect the beam in an organized pattern to distribute the laser energy without the need for the bulk and complications of the two raster scanning mirrors.

Laser-based coating removal systems use pulses of light from high power lasers to ablate or vaporize the paint or other coating from a surface. Each pulse removes the coating from a small region, typically 0.1 to 100 square mm by thermal ablation. The laser from an end-effector scanning tool is pointed to a different area after each pulse, where the removal process is repeated until the entire surface is cleaned. During thermal ablation, the temperature of surface material in the pulses' impact region can exceed 1500° C.

An advantage of lasers for coating removal is that each laser pulse removes a predictable portion of the thickness of the coating, in the small region impacted by the pulse. This opens the possibility of selective stripping where, for example, the topcoat could be removed but not the primer.

There have been numerous types of end-effector tools, such as U.S. Pat. No. 7,009,141. These conventional end-effector tools incorporate a surface contact configuration with an integrated waste vapor and particle collection and extraction. Byproducts enter the scanning head and mix internally with a purge-gas stream. This configuration captures laser ablation byproducts and reflected laser light that could represent health and safety hazards. Such hazards are especially significant in confined spaces, such as, but not limited to, an aircraft fuel tank, where combustible vapors from ablation products or tank contents may accumulate to concentrations within flammable limits. As such, ignition of combustible vapors and particles would be catastrophic. A drawback of these conventional end-effector tools is that ergonomic and confined space access constraints limit the size of the tool. Furthermore, surface irregularities from rivets and structural members in the tank constrain the tool configuration so that the surface contact configuration has limited utility.

### SUMMARY OF THE INVENTION

Embodiments of the present invention are directed to aperture adapters for a laser-based coating removal end-effector. The laser-based coating removal end-effector of the present invention is a coating removal device for removing a coating from a surface. The coating removal device is divided into separate components, such as a head component and a body component. Typically, the head component includes a socket to receive an aperture adapter and a joining mechanism that detachably engages the aperture adapter to the head component. In some embodiments, the joining mechanism is a retractable, spring-loaded, captive panel pin positioned on the head component. To engage and secure the aperture adapter, the pin is released into an insertion point of the aperture adapter; and, to disengage the aperture adapter, the pin is pulled and the aperture adapter is removed.

The coating removal device in some embodiments has a camera coupled to the body component, beneath the head component. The camera enables the operator to view the laser ablation processing region when the operation of the coating removal device is within a confined space. Preferably, the camera is a micro-camera. The camera in some embodiments is removable and replaceable.

Typically, the coating removal device has a hose coupled to the body component at one end and to a remote service unit at another end. The remote service unit pushes non-combustible purge gas through the hose and out of the aperture adapter at a rate sufficient to ensure that potential vapors in the laser ablation processing region remain below a lower flammability limit of the vapors. Types of non-combustible purge gas include, but are not limited to, air and nitrogen. In some embodiments, the purge gas flows at a positive pressure.

The coating removal device in some embodiments is adapted to couple to a handle apparatus. The handle apparatus is integrally formed with the body component or is coupled to the body component using a plurality of fasteners, such as screws, bolts, rivets, and the like. The handle apparatus preferably optimizes ergonomics of the coating removal device.

The aperture adapters of the present invention preferably do not require surface contact. Instead, the aperture adapters are configured to discharge non-combustible purge gas from the remote service unit. Preferably, the aperture adapters are configured for quick replacement during operation to meet varying uses of the coating removal device. The aperture adapters include, but are not limited to, a straight aperture adapter and an angled laser aperture adapter having a beam deflection feature to deflect laser beams at an angle up to 90°. The aperture adapters of all embodiments are configured for specified deflections of laser beams to improve access in confined spaces.

The coating removal device in some embodiments is adapted to couple to a waste collection shroud. The waste collection shroud comprises a nose cone, a body, and two evacuation tubes which are coupled to a waste removal apparatus at one end and to the body at another end. The waste removal apparatus in some embodiments functions to remove vaporous and particulate waste products that issue from the laser ablation processing. Typically, when the waste collection shroud is coupled to the coating removal device, the body component is positioned between the two evacuation tubes and an aperture adapter is coupled to a portion of the body between the two evacuation tubes. In some embodiments, evacuation pressure within the evacuation tubes is below atmospheric.

During operation, the coating removal device is coupled to the waste collection shroud. The waste collection shroud is typically positioned over the straight aperture adapter. This configuration achieves 100% collection of the ablation process waste products without surface contact by establishing a suction flow normal to and in the direction toward a centerline of the straight aperture, despite the presence of the purge flow that is ejected along with the laser pulses from the straight aperture. Sufficient velocity of the centerline-normal suction flow is needed to entrain the waste products that are emitted from the ablation region.

### BRIEF DESCRIPTION OF THE DRAWINGS

FIG. 1 illustrates an isometric view of an exemplary coating removal device in accordance with the present invention.

FIG. 2A illustrates an isometric view of an exemplary straight aperture adapter in accordance with the present invention.

FIG. 2B illustrates an isometric view of an exemplary angled laser aperture adapter in accordance with the present invention.

FIG. 3 illustrates an isometric view of an exemplary camera coupled to an end of a body component of the coating removal device in accordance with the present invention.

FIG. 4A illustrates an isometric view of an exemplary waste collection shroud in accordance with the present invention.

FIG. 4B illustrates a schematic view of the waste collection shroud taken along the A-A line of FIG. 4A.

FIG. 4C illustrates an isometric view of the waste collection shroud coupled to the coating removal device in accordance with the present invention.

### DETAILED DESCRIPTION OF THE PRESENT INVENTION

In the following description, numerous details are set forth for purposes of explanation. However, one of ordinary skill in the art will realize that the invention may be practiced without the use of these specific details or with equivalent alternatives.

Reference will now be made in detail to implementations of the present invention as illustrated in the accompanying drawings. The same reference indicators will be used throughout the drawings and the following detailed description to refer to the same or like parts.

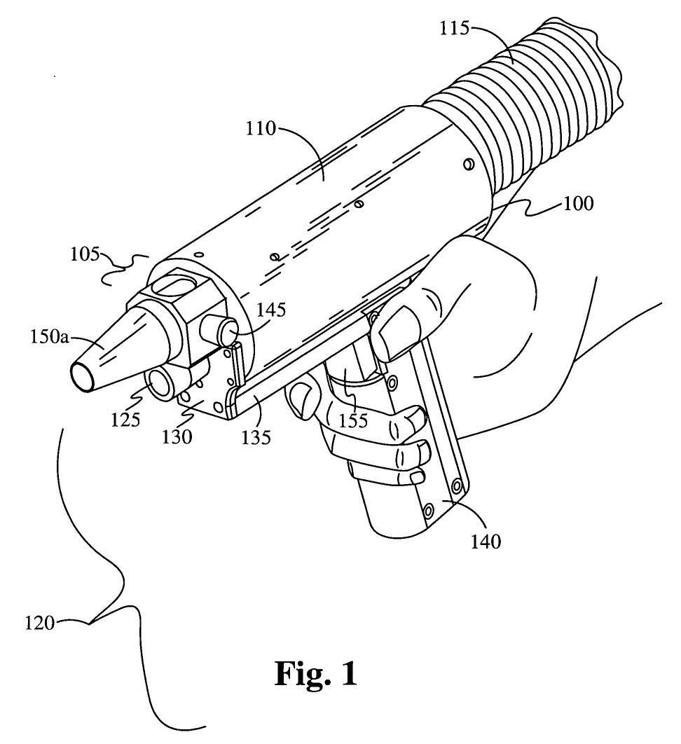

Embodiments of the present invention are directed to aperture adapters for a laser-based coating removal end-effector. The laser-based coating removal end-effector of the present invention is a coating removal device for removing a coating from a surface. FIG. 1 illustrates an isometric view of an exemplary coating removal device 100 in accordance with the present invention. Although not illustrated in FIG. 1, a hardware structure suitable for implementing the coating removal device is able to include a laser source, a beam splitter, scanning optics, one or more light illuminators, a photosensitive detector, a comparator, and a control unit. The hardware structure for implementing the coating removal device is not intended to be exhaustive, but rather is representative to highlight some components required by the present invention.

In some embodiments, the coating removal device 100 is divided into separate components, such as a head component 105 and a body component 110, each of which is coupled via fiber optic cables and/or power lines. The hardware structure described above is typically located in the head component 105, the body component 110, or both. Typically, the head component 105 includes a socket to receive an aperture adapter and a joining mechanism that detachably engages the aperture adapter to the head component 105. As illustrated in FIG. 1, the joining mechanism in some embodiments is a retractable, spring-loaded, captive panel pin 145 positioned on a side of the head component 105. Alternatively, the joining mechanism is able to be positioned on a top of the head component 105. To engage and secure the aperture adapter, the pin 145 is released into an insertion point of the aperture adapter; and, to disengage the aperture adapter, the pin 145 is pulled and the aperture adapter is removed. Various other joining mechanisms for detachably engaging the aperture adapter to the head component 105 include but are not limited to a circular notch on the head component 105 for receiving a spring-loaded knob on the aperture adapter. The joining mechanism preferably enables an operator to rapidly change and use another aperture adapter for a different application of the coating removal device 100.

At times, the operator operating the coating removal device 100 in a confined space is not able to see a particular region of an ablation surface. Operation of the coating removal device 100 within the confined space can be difficult. The coating removal device 100 in some embodiments has a camera 125 coupled to a side face of the body component 110, beneath the head component 105. As such, the camera 125 and supporting electronics and communication cabling advantageously enable the operator to view the laser ablation processing region when the operation of the coating removal device 100 is within the confined space. Particularly, the operator is provided with images of the laser ablation processing region that are shown on a display, such as a computer monitor or a television or any other suitable displays. Preferably, the camera 125 is a micro-camera. The camera 125 in some embodiments is removable and replaceable.

Typically, the coating removal device 100 has a hose 115 coupled to a distal side face of the body component 110 at one end and to a remote service unit (not illustrated) at another end. The hose 115 is typically flexible and long enough such that placement of the remote service unit does not hinder operation of the coating removal device 100. The remote service unit pushes non-combustible purge gas through the hose 115 and out of the aperture adapter at a rate sufficient to ensure that potential vapors in the laser ablation processing region remain below a lower flammability limit of the vapors. Types of non-combustible purge gas include, but are not limited to, air and nitrogen. Typically, a mass balance analysis is able to establish an appropriate flow rate of the purge gas under a conservative assumption that laser energy generates only combustible vapors.

The coating removal device 100 in some embodiments is adapted to couple to a handle apparatus 120. The handle apparatus 120 is integrally formed with the body component 110 or is coupled to the body component 110 using a plurality of fasteners, such as screws, bolts, rivets, and the like. Typically, the handle apparatus 120 has components including an end plate 130, a bottom plate 135, a hand grip 140, and a firing trigger 155. In some embodiments, the components are integrally formed. In other embodiments, the components are coupled together using a plurality of fasteners, such as screws, bolts, rivets, and the like. The handle apparatus 120 preferably optimizes ergonomics of the coating removal device 100, thereby reducing operator fatigue and discomfort.

The end plate 130 typically couples to the side face of the body component 110, beneath the head component 105. The end plate 130 in some embodiments is U-shaped such that the end plate 130 is formed around the camera 125. The end plate 130 perpendicularly couples to the bottom plate 135 in order for the body component 110 to be positioned on and supported by the bottom plate 135. The hand grip 140 in some embodiments is perpendicularly coupled to the bottom plate 135. Alternatively, the hand grip 140 is coupled to the bottom plate 135 at an angle away from the ablation surface.

The firing trigger 155 activates the coating removal device 100. Typically, circuitry within the handle apparatus 120 is coupled to the circuitry within the coating removal device 100.

The aperture adapters of the present invention preferably do not require surface contact. Instead, the aperture adapters are configured to discharge non-combustible purge gas from the remote service unit to ensure that combustible vapor concentrations near the ablation region remain well below the lower flammability limit. The aperture adapters typically operate at a predetermined distance away from the ablation surface. Preferably, the aperture adapters are configured for quick replacement during operation to meet varying uses of the coating removal device 100. The aperture adapters in some embodiments are made of metal.

In some embodiments, once the coating removal device 100 is activated by the firing trigger 155, pressure sensors (not illustrated) are used to ensure that sufficient flow rate of the purge gas is present before pulses of high power laser beams can start. The pressure sensors in some embodiments are located within the head component 105 of the coating removal device 100. As described above, the purge gas preferably limits the concentration of potentially combustible vapors to levels significantly below the lower flammability limit.

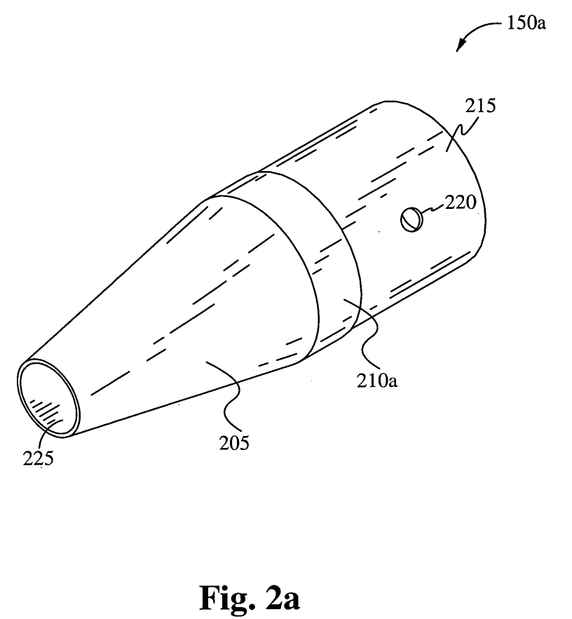

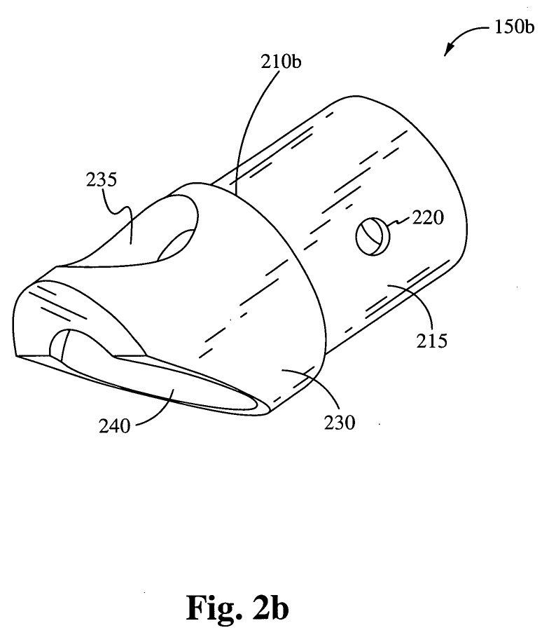

As illustrated in FIG. 1, the aperture adapter coupled to the head component 105 is a straight aperture adapter 150a. FIG. 2A illustrates an isometric view of the straight aperture adapter 150a in accordance with the present invention. The straight aperture adapter 150a has two parts. A first part is a tapered end 205. The tapered end 205 has an outlet 225 to emit light (e.g., laser beam) and to purge gas, such as air or nitrogen. The tapered end 205 also has a reference shoulder 210a for positioning the straight aperture adapter 150a into and within the socket of the head component 105. A second part is a cylindrical end 215 for coupling to the head component 105. The cylindrical end 215 is typically positioned within the socket of the head component 105. In some embodiments, the cylindrical end 215 has an insertion point 220 for the retractable, spring-loaded, captive panel pin 145 of the head component 105 to insert into. Alternatively, the cylindrical end 215 has a spring-loaded knob for inserting into the circular notch of the head component 105.

Alternatively, an angled laser aperture adapter is able to be coupled to the head component 105. FIG. 2B illustrates an isometric view of the angled laser aperture adapter 150b in accordance with the present invention. The angled laser aperture adapter 150b has two parts. A first part is an angled end 230 having a beam deflection feature 240, such as a mirror, to deflect light such as laser beams at an angle up to 90° off an axis of the coating removal device 100 for improved access around surface irregularities of the ablation surface. The angled end 230 also has an outlet 235 to emit light and purge gas. The angled end 230 also has a reference shoulder 210b for positioning the angled laser aperture adapter 150b into and within the socket of the head component 105. A second part is the cylindrical end 215 described above for coupling to the head component 105. In some embodiments, the beam deflection feature 240 is adjustable to allow a specific deflection of the laser beams. The aperture adapters of all embodiments are configured for specified deflections of laser beams to improve access in confined spaces.

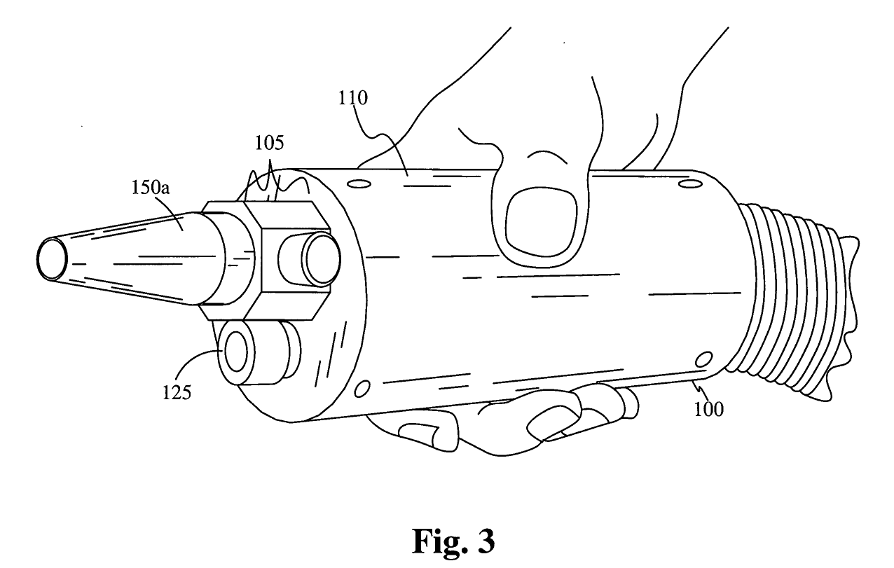

In some embodiments, the camera 125 is configured to be in use with the straight aperture adapter 150a, as illustrated in FIGS. 1 and 3. FIG. 1 illustrates the coating removal device 100 coupled to the handle apparatus 120. As described above, the end plate 130 forms around the camera 125, as described above. FIG. 3 illustrates the coating removal device 100 without the handle apparatus 120. As illustrated, the camera 125 can be used with or without the handle apparatus 120. The camera 125 in some embodiments is coupled to the side face of the body component 110, beneath the head component 105 and the straight aperture adapter 150a. In other embodiments, the camera 125 is configured to be in use with other aperture adapters, such as the angled laser aperture adapter 150b.

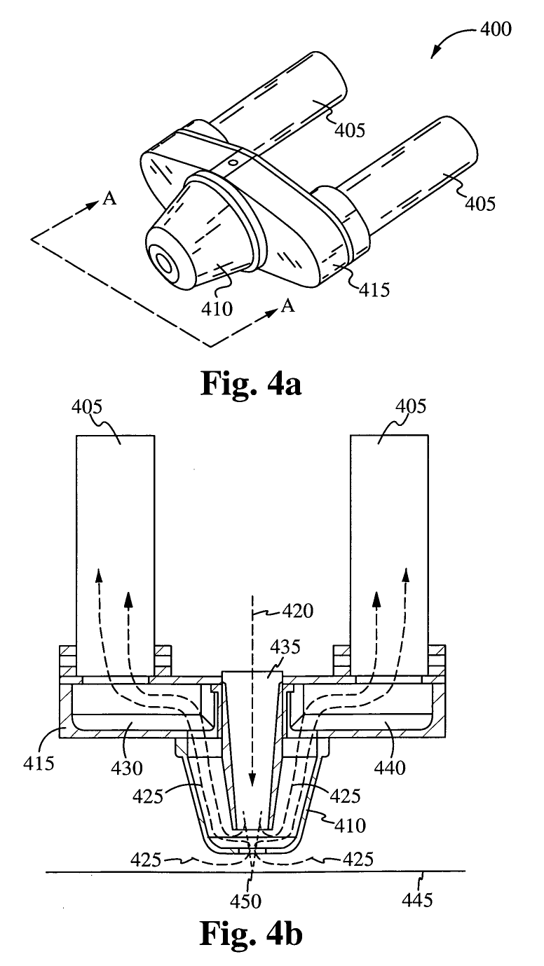

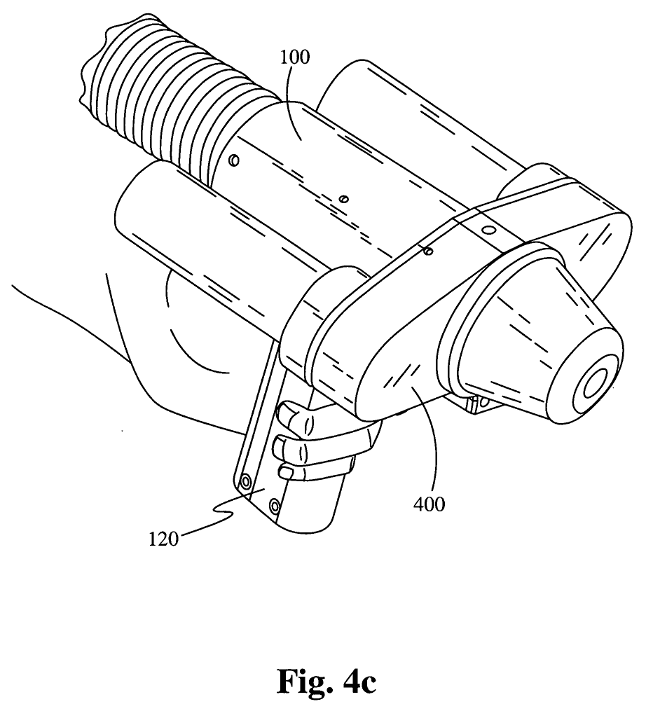

The coating removal device 100 in some embodiments is adapted to couple to a waste collection shroud. FIGS. 4A-4C illustrate an exemplary waste collection shroud 400 in accordance with the present invention. FIG. 4A illustrates an isometric view of the waste collection shroud 400 in accordance with the present invention, while FIG. 4B illustrates a schematic view of the waste collection shroud 400 taken along the A-A line of FIG. 4A.

Referring to FIG. 4A, the waste collection shroud 400 comprises a nose cone 410, a body 415, and evacuation tubes 405. Preferably, the waste collection shroud 400 uses two evacuation tubes 405 that are coupled to a waste removal apparatus (not illustrated) at one end and to the body 415 at another end. The waste removal apparatus in some embodiments functions to remove vaporous and particulate waste products that issue from the laser ablation processing. Typically, the waste removal apparatus prevents condensation or re-deposition of the vaporous or particulate waste products back onto the laser-treated surfaces during processing, which advantageously preserves cleanliness and surface properties of treated surfaces following the laser ablation processing.

Typically, when the waste collection shroud 400 is coupled to the coating removal device 100, the body component 110 is positioned between the two evacuation tubes 405, and an aperture adapter is coupled to a portion of the body 415 between the two evacuation tubes 405. In some embodiments, the evacuation tubes 405 are replaceable and removable. The evacuation tubes 405 are typically flexible and long enough to couple to the waste removal apparatus.

In some embodiments, the nose cone 410 and the body 415 are integrally formed. Alternatively, the nose cone 410 and the body 415 are coupled using adhesive, bolts, nuts, rivets or other coupling means. Preferably, the nose cone 410 and the body 415 together form three distinct sections or passageways, as illustrated in FIG. 4B. A first passageway 430 and a third passageway 440 direct entrained waste products to the evacuation tubes 405 that eventually lead to the waste removal apparatus. Dotted lines 425 illustrate the flow of the entrained waste products through an opening of the nose cone 410. In some embodiments, evacuation pressure within the evacuation tubes 405 is below atmospheric.

A second passageway 435, positioned between the first passageway 430 and the third passageway 440, is a convergent nozzle to allow purge gas from the remote service unit to flow out of the opening of the nose cone 410. A distal end of the second passageway 435 is adapted to couple to an aperture adapter, such as a straight aperture adapter 150a, which in turn couples to head component 105 of the coating removal device 100. In some embodiments, the tapered end 205 of the straight aperture adapter 150a fits entirely within the second passageway 435. During operation, while the purge gas flows at positive pressure through the second passageway 435 and toward the opening of the nose cone 410, the entrained waste products flow in from the opening of the nose cone 410 around both sides of the purge gas flow and through the first passageway 430 and the third passageway 440. Dotted line 420 illustrates the flow of the purge gas. The dotted line 425 outside of the nose cone 410 shows the flow of entrained gas from surroundings such as from laser ablation regions, and the dotted line 425 within the nose cone 410 shows the flow of a mixture of purge gas, entrained waste products, and entrained gas from the surroundings.

FIG. 4B also illustrates an ablation surface 445. During operation, the coating removal device 100 is coupled to the waste collection shroud 400 as illustrated in FIG. 4C. As discussed above, non-combustible purge gas flows toward the opening of the nose cone 410 coaxially with laser beams. The laser beams are directed to a predetermined region 450 on the ablation surface 445. The non-combustible purge gas preferably controls the combustible vapor concentrations in and near the ablation region 450 below the lower flammability limit. Waste products such as vapor ejecta created from the laser ablation processing are collected and evacuated by the waste collection shroud 400. Preferably, the waste products are evacuated through the first passageway 430 and the third passageway 440 and through the evacuation hoses 405 to the waste removal apparatus.

Referring to FIG. 4C, the waste collection shroud 400 is typically positioned over the straight aperture adapter 150a. This configuration achieves 100% collection of the ablation process waste products without surface contact by establishing a suction flow normal to and in the direction toward a centerline of the straight aperture adapter 150a, despite the presence of the purge flow that is ejected along with the laser pulses from the straight aperture adapter 150a. Sufficient velocity of the centerline-normal suction flow is needed to entrain the waste products that are emitted from the ablation region 450. Typically, the evacuation rate is a sum of the suction flow and the purge flow rate.

In other embodiments, the nose cone 410 and the body 415 of the waste collection shroud 400 together form two distinct passageways instead of three distinct passageways as described above. In this configuration, the waste products are evacuated through a first passageway, and non-combustible purge gas flows out coaxially with laser beams through a second passageway. It should be understood that the described embodiments of the waste collection shroud 400 are presented by way of example only and do not limit the invention.

In some embodiments, the camera 125 is first removed from the side face of the body component 110 before the waste collection shroud 400 is positioned over the straight aperture adapter 150a. In other embodiments, the camera 125 does not need to be removed and is able to be used concurrently with the waste collection shroud 400. Yet, in other embodiments, the waste collection shroud 400 is able to be used with other aperture adapters, such as the angled laser aperture adapter 150b described above.

In operation, the straight aperture adapter 150a, for example, is coupled to the head component 105 of the coating removal device 100. Particularly, the straight aperture adapter 150a is positioned within the socket of the head component 105 until the insertion point 220 and the retractable, spring-loaded captive panel pin 145 align. The pin 145 is pulled to fully insert the aperture adapter 150a within the socket. The pin 145 is released into the insertion point 220 to engage and secure the straight aperture adapter 150a. The pin 145 allows the operator to rapidly change and use another aperture adapter for another application of the coating removal device 100. If desired, the camera 125 is coupled to the body component 110 of the coating removal device 100. The camera 125 allows the operator to view the images of the laser ablation processing region on the remote display. Alternatively, the camera 125 is able to be decoupled from the body component 110 if the operator need not view images on the remote display. Similarly, if desired, the handle apparatus 120 is coupled to the body component 110. The handle apparatus 120 preferably optimizes ergonomics of the coating removal device 100, thereby reducing operator fatigue and discomfort. Next, the waste collection shroud 400 is coupled to the coating removal device 100. Particularly, the body component 110 is positioned between the two evacuation tubes 405, and the straight aperture adapter 150a fits entirely within the convergent nozzle of the waste collection shroud 400. Preferably, the remote service unit and the waste removal apparatus are positioned such that they do not hinder the laser ablation process.

The coating removal device 100 is positioned such that the nose cone 410 is at a distance away from the predetermined region 450 on the ablation surface 445. The coating removal device 100 is activated by the firing trigger 155 of the handle apparatus 120. Alternatively, the coating removal device 100 is activated by a switch on the body component 110 if the handle apparatus 120 is not used. The purge gas first exits through the second passageway 435 of the waste collection shroud 400. The purge gas and entrained gas from the surroundings preferably control the combustible vapor concentrations in and near the ablation region 450 below the lower flammability limit. The pressure sensors ensure that sufficient flow rate of the purge gas is present before pulses of high power laser beams start. Once sufficient flow rate is present, the laser beams also exit out of the nose cone 410. The coating removal device 100 is pointed to a different area after each pulse until a desired portion of the ablation surface 445 is cleaned. The waste products created from the laser ablation processing are collected and evacuated by the waste collection shroud 400 into the waste removal apparatus. The coating removal device 100 of the present invention collects all the waste products without surface contact by establishing the suction flow normal to and in the direction toward the centerline of the coating removal device 100, despite the presence of the purge flow that is ejected along with the laser pulses from the straight aperture adapter 150a.

Accordingly, the configuration of at least the coating removal device 100, the straight aperture adapter 150a, and the waste collection shroud 400 is able to be used without contacting the ablation surface 145 during the laser ablation processing, such as in confined spaces and/or on surface irregularities. As described above, the camera 125 and the handle apparatus 120 are not necessary during the laser ablation processing. However, the camera 125 and the handle apparatus 120 are able to advantageously assist the operator during the laser ablation processing.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. A device to remove a coating from a surface, the device comprising:
a. a body component;
b. a head component coupled to a first end of the body component;
c. a removable aperture adapter adapted to couple to the head component, wherein the removable aperture adapter does not require contact with the surface; and
d. a joining mechanism configured to detachably engage the removable aperture adapter to the head component, wherein waste products are collected by using a suction flow normal to an axis of the device.

2. The device of claim 1 wherein the joining mechanism enables an operator to change and use another removable aperture adapter for a different application of the device.

3. The device of claim 1 wherein the removable aperture adapter is configured to discharge non-combustible purge gas to ensure that vapor concentrations near an ablation region remain below a flammability limit.

4. The device of claim 1 wherein the removable aperture adapter is a straight aperture adapter having a tapered end, wherein the tapered end has an outlet to emit light and purge gas.

5. The device of claim 1 wherein the removable aperture adapter is an angled laser aperture adapter having an angled end, wherein the angled end has a beam deflection feature and an outlet to emit light and purge gas, and wherein the deflection feature deflects the light at an angle up to 90° off the axis of the coating removal device.

6. The device of claim 1 further comprising pressure sensors to ensure sufficient flow rate of purge gas is present, wherein the purge gas flows at a positive pressure.

7. The device of claim 1 further comprising a camera coupled to a portion on the first end of the body component, wherein the camera enables an operator to view images of laser ablation processing on a display.

8. The device of claim 1 further comprising a hose coupled to remote service unit and a second end of the body component, wherein the remote service unit pushes non-combustible purge gas through the hose and the removable aperture adapter at a rate sufficient to ensure that potential vapors remain below a flammability limit.

9. The device of claim 1 further comprising a handle apparatus adapted to couple to the body component, wherein the handle apparatus is configured to optimize ergonomics of the device.

10. The device of claim 1 further comprising a waste collection shroud adapted to couple to the head component, wherein the waste collection shroud has a nose cone, a body, and at least one evacuation tube.

11. The device of claim 10 wherein the at least one evacuation tube is coupled to a waste removal apparatus, the waste removal apparatus removes the waste products that issue from a laser ablation process.

12. The device of claim 10 wherein evacuation pressure within the at least one evacuation tube is below atmospheric.

13. The device of claim 10 wherein the nose cone and the body form at least two passageways, wherein a first passageway directs the waste products to the at least one evacuation tube and a second passageway allows purge gas to flow out of the nose cone, and wherein the purge gas flows out of the nose cone coaxially with laser beams.

14. A tool to remove a coating from a surface, the tool comprising:
a. a body component;
b. a head component coupled to a first end of the body component;
c. a waste collection shroud adapted to couple to the head component, wherein the waste collection shroud has a nose cone, a body, and at least one evacuation tube; and
d. a joining mechanism configured to detachably engage a removable aperture adapter to the head component, wherein waste products are collected by using a suction flow normal to an axis of the tool.

15. The tool of claim 14 wherein the joining mechanism enables an operator to change and use another removable aperture adapter for a different application of the tool.

16. The tool of claim 14 wherein the removable aperture adapter is adapted to couple to the head component, wherein the aperture adapter does not require contact with the surface.

17. The tool of claim 14 wherein the removable aperture adapter is configured to discharge non-combustible purge gas to ensure that vapor concentrations near an ablation region remain below a flammability limit.

18. The tool of claim 14 wherein the removable aperture adapter is a straight aperture adapter having a tapered end, wherein the tapered end has an outlet to emit light and purge gas.

19. The tool of claim 14 wherein the removable aperture adapter is an angled laser aperture adapter having an angled end, wherein the angled end has a beam deflection feature and an outlet to emit light and purge gas, and wherein the deflection feature deflects the light at an angle up to 90° off the axis of the coating removal device.

20. The tool of claim 14 wherein the at least one evacuation tube is coupled to a waste removal apparatus, the waste removal apparatus removes the waste products that issue from a laser ablation process.

21. The tool of claim 14 wherein evacuation pressure within the at least one evacuation tube is below atmospheric.

22. The tool of claim 14 wherein the nose cone and the body form at least two passageways, wherein a first passageway directs the waste products to the at least one evacuation tube and a second passageway allows purge gas to flow out of the nose cone, and wherein the purge gas flows out of the nose cone coaxially with laser beams.

23. The tool of claim 14 further comprising pressure sensors to ensure sufficient flow rate of purge gas is present, wherein the purge gas flows at a positive pressure.

24. The tool of claim 14 further comprising a camera coupled to a portion on the first end of the body component, wherein the camera enables an operator to view images of laser ablation processing on a display.

25. The tool of claim 14 further comprising a hose coupled to remote service unit and a second end of the body component, wherein the remote service unit pushes non-combustible purge gas through the hose and the removable aperture adapter at a rate sufficient to ensure that potential vapors remain below a flammability limit.

26. The tool of claim 14 further comprising a handle apparatus adapted to couple to the body component, wherein the handle apparatus is configured to optimize ergonomics of the tool.

27. An aperture adapter used with a coating removal device to remove a coating from a surface, the aperture adapter comprising:
a. a first end having an outlet to emit light and purge gas; and
b. a second end for coupling to the coating removal device, wherein the removable aperture adapter does not require contact with the surface during laser ablation processing and is configured for specified deflections of laser beams.

28. The aperture adapter of claim 27 wherein the first end is a tapered end.

29. The aperture adapter of claim 27 wherein the first end is an angled end having a beam deflection feature to deflect the light at an angle up to 90° off the axis of the coating removal device.

30. The aperture adapter of claim 27 wherein waste products are collected by using a suction flow normal to an axis of the coating removal device despite presence of the purge gas that is ejected along with the light.

31. A method of using a coating removal device, the method comprising:
a. engaging an aperture adapter to the coating removal device;
b. coupling a waste collection shroud to the coating removal device;
c. positioning the coating removal device at a distance away from a predetermined region on an ablation surface;
d. activating the coating removal device, thereby ensuring sufficient flow rate of purge gas is present before pulses of high power laser beams start; and
e. repeating activating the coating removal device until a desired portion of the ablation surface is cleaned.

32. The method of claim 31 wherein the activating comprises ejecting purge gas along with the laser pulses, and collecting waste products in and near the ablation region without surface contact.

33. The method of claim 31 further comprising attaching a detachable camera to the coating removal device, thereby allowing an operator to view the predetermined region.

34. The method of claim 31 further comprising coupling a handle apparatus configured to optimize ergonomics of the coating removal device.
